(19) United States
(12) Patent Application Publication
(10) Pub. No.: US 2006/0180740 A1
(43) Pub. Date: Aug. 17, 2006

(54) Method and apparatus for invisible headlights

(76) Inventors: John L. Barrett, Pelham, NH (US); Peter A. Ketteridge, Amherst, NH (US)

Correspondence Address: Hayes Soloway PC, 175 Canal Street, Manchester, NH, 03101, US

(21) Appl. No.: 11/056,873

(22) Filed: Feb. 11, 2005

(51) Int. Cl. H01J 40/14; H01J 43/00

(52) U.S. Cl. 250/207; 250/214 VT; 313/103 CM; 313/105 CM

(57) ABSTRACT

A night vision device includes an emitter having a surface band gap material integral with the surface of the emitter. A structure of uniformly spaced apertures formed by the photon band gap material. A heat source for heating the emitter is provided proximate to the emitter. When the emitter is heated, the emitter causes the photon band gap material to emit photons in the infrared bands of radiation, which have a wavelength between one hundred nanometers and one micrometer. An infrared viewing system is provided for viewing infrared bands of radiation emitted by the emitter and band gap material.

### FIELD OF THE INVENTION

The present invention relates to ordnance and more particularly to methods and apparatus for providing a night vision system.

### BACKGROUND OF THE INVENTION

Needs exist, in military applications, police applications, and other endeavors, to see in the dark without drawing attention. Specifically, during a military activity, with an enemy nearby, the use of a flashlight or other light source can draw attention and result in revealing the presence and location of the military member. Devices are needed that provide night vision without revealing the position of the person using the device.

One commonly used type of device is an infrared night vision system. These systems can make use of ambient infrared light to create an image on a viewable display. The viewable display can be put on a monitor or some type of goggles or headset worn over the eyes. Unfortunately, these systems are limited by the availability of ambient infrared light. Also, the range of many infrared night vision systems is limited, making high velocity travel, such as vehicular travel, dangerous.

Thus, a heretofore unaddressed need exists in the industry to address the aforementioned deficiencies and inadequacies.

### SUMMARY OF THE INVENTION

Embodiments of the present invention provide a system and method for enabling vision in the absence of visible light. Briefly described in architecture, one embodiment of the system, among others, can be implemented as follows. The headlight device includes an emitter having a surface. A photon band gap material is integral with the surface of the emitter. A structure of apertures is formed, defined by the photon band gap material. A heat source for heating the emitter is provided, either directly in contact with or proximate to the emitter. An infrared viewing system is provided for viewing infrared bands of radiation emitted by the emitter.

In another aspect, the invention features a method of enabling vision in the absence of visible light. The method includes the steps of: heating an emitter; generating thermally excited outputs in the photon band gap material; emitting photons from the photon band gap material at selected wavelengths between approximately 700 nanometers and approximately one millimeter; and viewing the photons with an infrared viewing system.

Other couplings, systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 shows an exemplary illustration of the invention in use.

FIG. 2 is a perspective view of a first exemplary embodiment of the invention.

FIG. 3 is a cross-sectional view of the invention shown in FIG. 2, in accordance with the first exemplary embodiment of the invention.

FIG. 4 shows a portion of cross-section of an exemplary photon band gap spectral emitter in accordance with the principles of the invention.

FIG. 5 is a first exemplary graph of the spectral radiant emissions from the exemplary photon band gap spectral emitter of FIG. 4.

FIG. 6 is a second exemplary graph of the spectral radiant emissions from the exemplary photon band gap spectral emitter of FIG. 4.

FIG. 7 is a cross-sectional view of the invention, in accordance with a second exemplary embodiment of the invention.

FIG. 8 is a flow chart illustrating one method of using the invention shown in FIG. 3, in accordance with the first exemplary embodiment of the present invention.

### DETAILED DESCRIPTION OF THE DRAWINGS

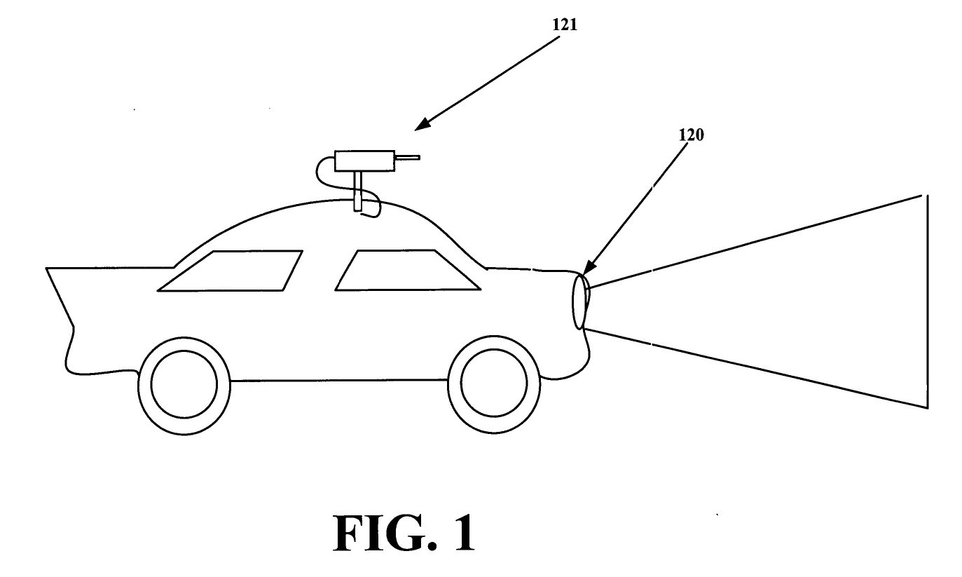

FIG. 1 shows an exemplary illustration of the invention in use. The concept of the invention is to radiate infrared light from a night vision device 120, permitting vision using an infrared viewing system 121. Those having ordinary skill in the art know of a variety of infrared viewing systems 121 that would be applicable for use with the night vision device 120. The present application is directed primarily toward the night vision device 120.

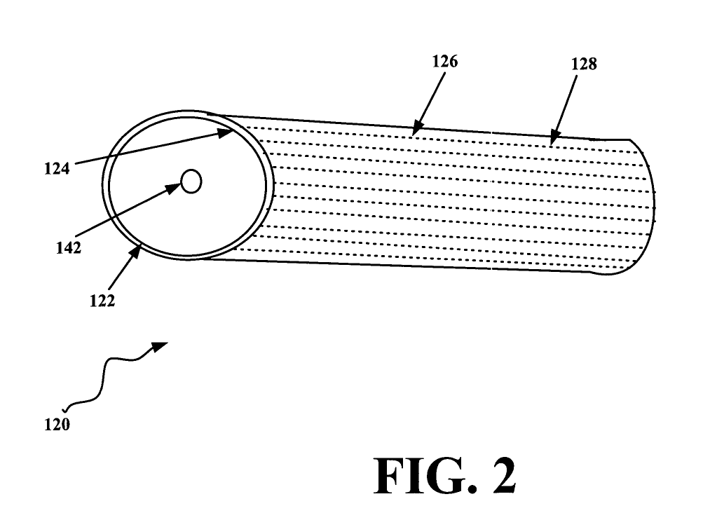

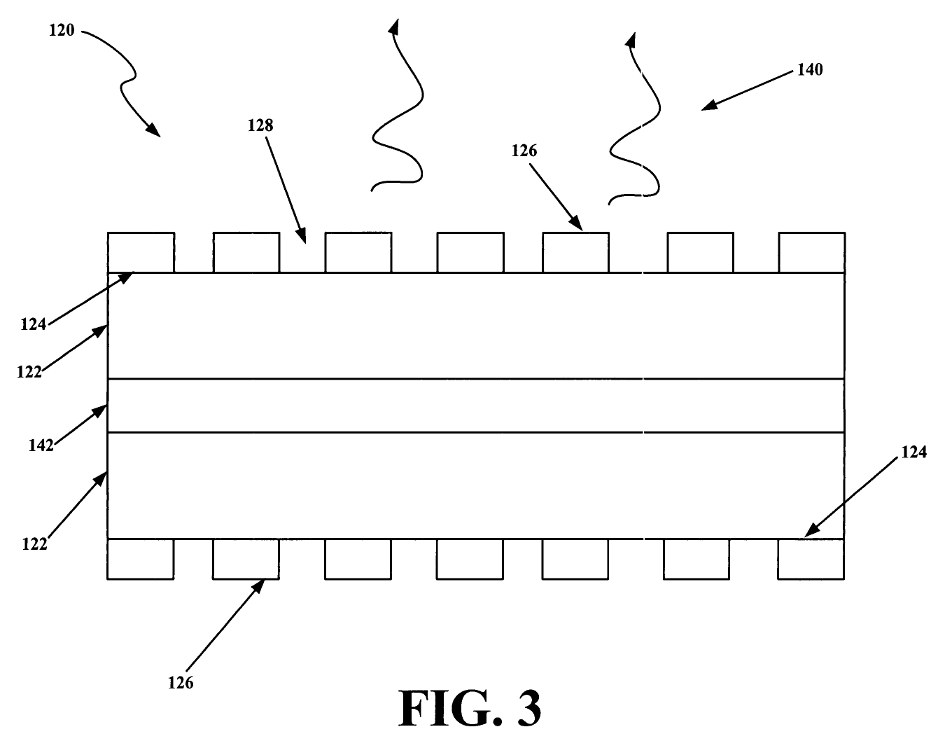

A night vision device 120, in accordance with a first exemplary embodiment of the present invention, is shown in FIG. 2 and FIG. 3. FIG. 2 is a perspective view of a first exemplary embodiment of the invention. FIG. 3 is a cross-sectional view of the invention shown in FIG. 2, in accordance with the first exemplary embodiment of the invention. A night vision device 120 includes an emitter 122 having a surface 124. A band gap material 126 is integral with the surface 124 of the emitter 122. A structure of apertures 128 is formed by the photon band gap material 126. A heat source 142 for heating the emitter 122 is provided proximate to the emitter 122. An infrared viewing system 121 (shown only in FIG. 1) is provided for viewing infrared bands of radiation emitted by the emitter 122.

Material for the emitter 122 and the photon band gap material 126 may be selected based on its ability to withstand temperatures of at least 500 Kelvin without significant degradation. One robust material that may be used for the emitter 122 is silicon. Of course, other types of material may be used, depending on the ability of the material to withstand temperatures without significant degradation and a need for the material to withstand degradation. Certainly, disposable applications for the night vision device 120 will not require as robust an emitter 122. The photon band gap material 126 may be a type of metal. Of course, other types of material may be utilized as the photon band gap material 126, depending on the thermal and electrical conductivity of the material and the ability of the material to restrain thermally excited outputs 30. in particular, tungsten may form the photon band gap material and can be heated directly to much higher temperatures.

The apertures 128 in the structure of apertures 128 may be uniformly spaced. Research has suggested that spacing of the apertures 128 may directly impact the wavelength band of emitted photons 140. The apertures 128 in the structure of apertures 128 may also be consistently sized. Research has suggested that the sizing of the apertures 128 may directly impact the wavelength band of emitted photons 140. For instance, apertures 128 consistently sized at approximately 3 microns in diameter and spaced approximately 5 microns apart (center-to-center) may produce emitted photons 140 in the wavelength band of 3-5 microns, as shown in FIG. 3. Thickness of the photon band gap material 126 may further influence the wavelength band of emitted photons and their intensity 140.

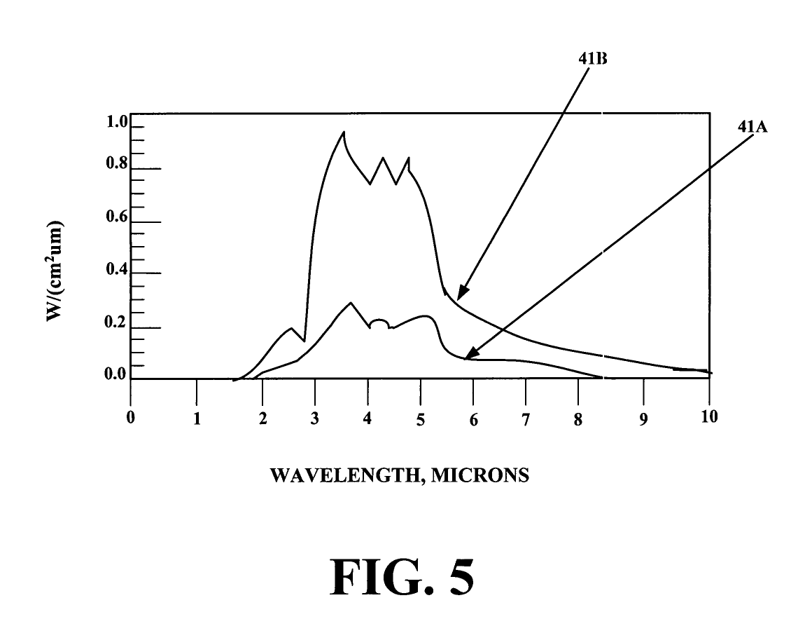

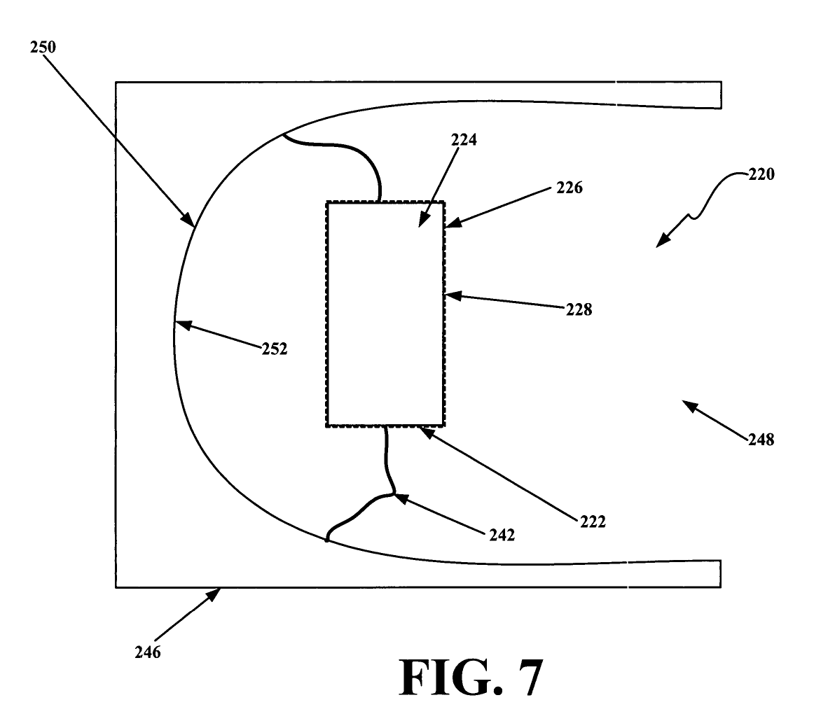

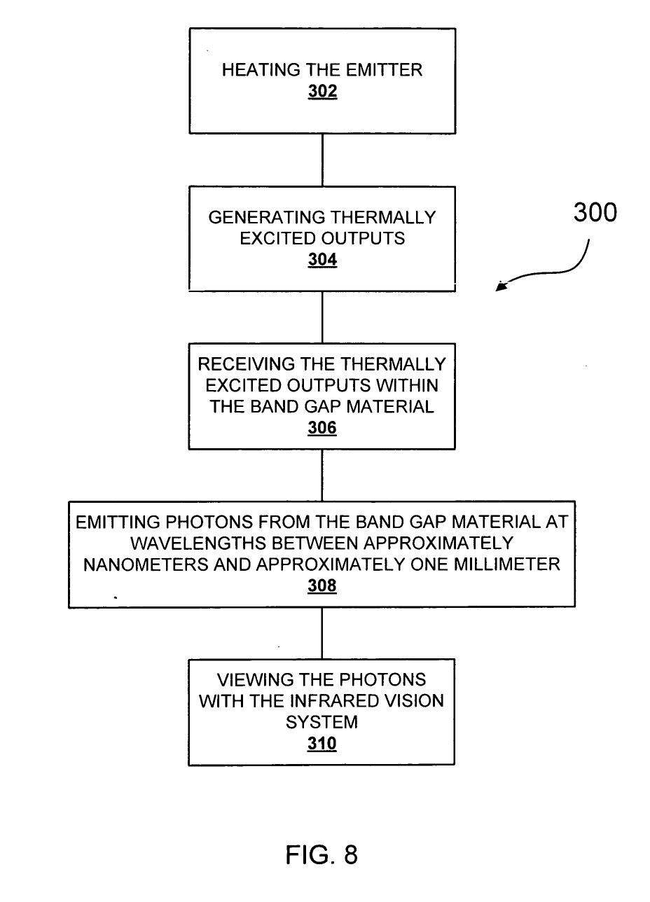

Operation of the night vision device 120 requires the emitter 122 be heated. The emitter 122 may be heated to at least 500 Kelvin, which will produce some emitted photons 140. The emitter 122 may be heated to at least 700 Kelvin, which will produce significant emitted photons 140, as shown in FIG. 5. The heat source 142 may be mounted proximate to the emitter 122. Mounting the heat source 142 proximate to the emitter 122 may involve mounting the heat source 142 directly to the emitter 122. In addition, mounting the heat source 142 proximate to the emitter 122 may involve running current through the emitter 122 or a portion of the emitter 122 and generating current resistive heat. As shown in FIG. 7 and FIG. 8, mounting the heat source 142 may also involve mounting a heat source 142 within the emitter 122. Those having ordinary skill in the art will recognize a number of other possibilities exist for providing a heat source 142 for the emitter 122.

The night vision device 120 may substantially limit emitted photons 140 to a wavelength band approximately one micron wide. Limiting emitted photons 140 to a narrow wavelength band may increase output along that wavelength band. The infrared viewing system may be designed such that it is attuned to the wavelength band of the emitted photons 140.

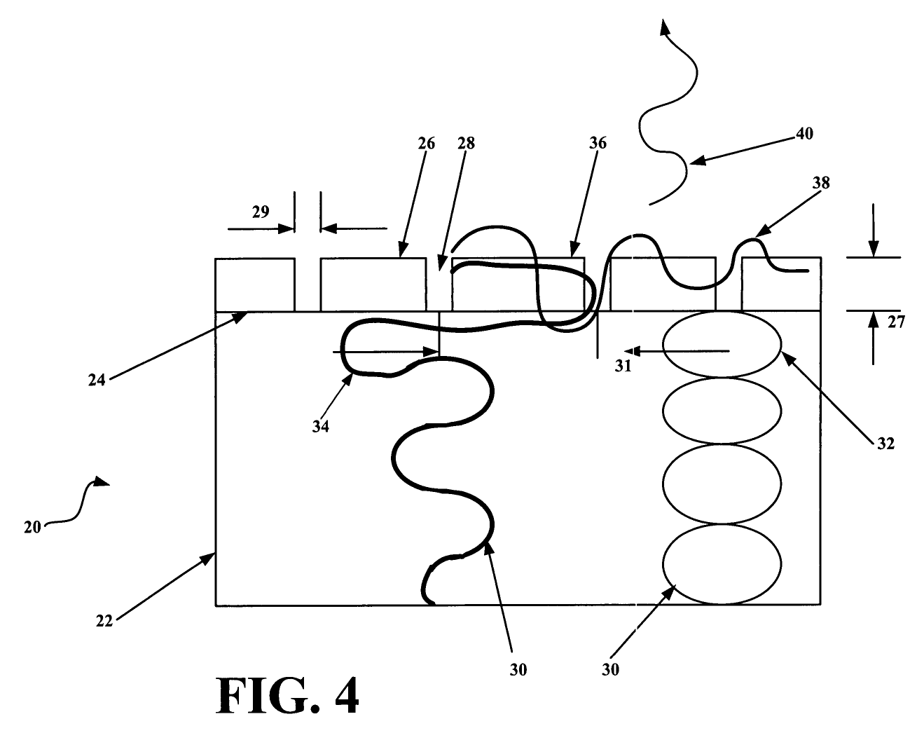

An exemplary photon band gap spectral emitter 20, which is part of the basis for the present invention, is illustrated in FIG. 4. FIG. 4 shows a portion of cross-section of an emitter 22 having a band gap material 26 integral with a surface 24 of the emitter 22. The photon band gap material 26 has a structure of apertures 28. Physics teaches that when a body is thermally excited that body will emit energy. That energy can be described as photons over a wavelength band. The radiance and wavelength of the energy will be affected by a number of factors, such as the temperature to which the body is thermally excited and, in this case, by the surface structure. When the emitter 22 is thermally excited, the emitter 22, like any body, begins creating thermally excited outputs 30.

In the example shown in FIG. 4, the photon band gap material 26 restricts some of the thermally excited outputs 30 from being emitted from the thermally excited emitter 22. The restricted thermally excited outputs 32 reflect back from the surface 24 and the photon band gap material 26. The unrestricted thermally excited outputs 34 are released into a band gap surface 36, where the unrestricted thermally excited outputs 34 interact with surface plasmons 38. As the surface plasmons 38 decay, the energy is released as emitted photons 40. In this example, the thickness of the photon band gap material 26, the size of the apertures 28, and the distance between the apertures impact the wavelengths of the emitted photons 40.

The restricted thermally excited outputs 32 do not become wasted energy. Instead, after reflecting within the emitter 22 for a period of time, the restricted thermally excited outputs 32 bleed into the unrestricted thermally excited outputs 34. Following the same course as the unrestricted thermally excited outputs 34, the restricted thermally excited outputs 32 eventually become part of the emitted photons 40, exhibiting similar wavelengths to the unrestricted thermally excited outputs 34. In this regard, the photon band gap material 26 does not simply filter thermally excited outputs 30 for emitted photons 40 of desired wavelengths. Instead, the photon band gap material 26 also helps to convert the thermally excited outputs 30 that would otherwise become emitted photons 40 of undesired wavelengths into emitted photons 40 of desired wavelengths, thus conserving the output of thermal energy.

FIG. 5 is a first exemplary graph of the spectral radiant emissions from the exemplary photon band gap spectral emitter of FIG. 4. The graph contains emission curves for two different temperatures, 600 Kelvin and 720 Kelvin, of the emitter 22 in the exemplary photon band gap spectral emitter 20. For illustrative purposes, wavelength of the emitted photons 40 for the exemplary photon band gap spectral emitter 20 was made to be primarily between approximately 3 and 5 microns. As previously discussed, the thickness of the photon band gap material 26, the size of the apertures 28, and the distance between the apertures 28 impact the wavelengths of the emitted photons 40. However, the wavelength of emitted photons 40 are not significantly impacted by the temperature of the emitter 22. Hence, the significant portion of the emitted photons 40 for this example will remain between 3 and 5 microns, regardless of the temperature chosen. This characteristic makes the photon band gap spectral emitter 20 scalable. Maxwell's equations, which are scale free, imply that any wavelength may be attained, using the proper spacing.

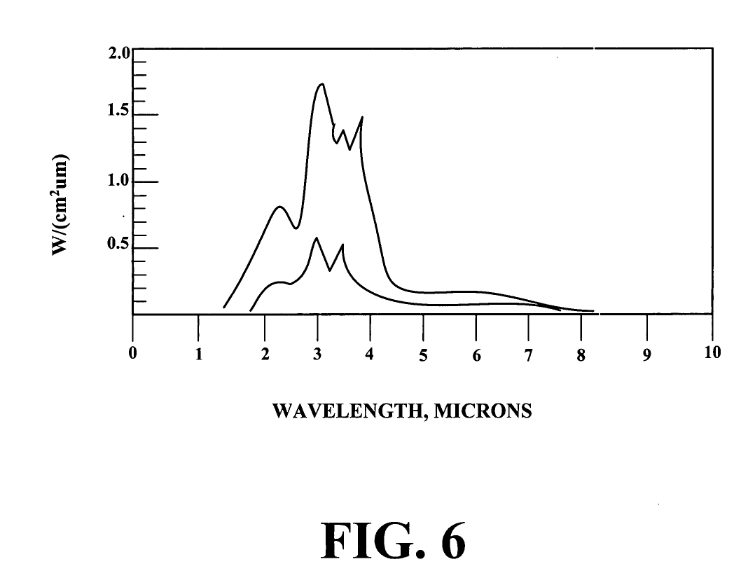

FIG. 6 is a second exemplary graph of the spectral radiant emissions from the exemplary photon band gap spectral emitter of FIG. 4. The graph contains emission curves for two different temperatures, 600 Kelvin and 720 Kelvin, of the emitter 22 in the exemplary photon band gap spectral emitter 20. For illustrative purposes, wavelength of the emitted photons 40 for the exemplary photon band gap spectral emitter 20 was made to be primarily between approximately 3 and 4 microns, half the bandwidth of FIG. 5. Of course, other photon band gap spectral emitters 20 can be designed according to the description provided herein to emit photons of other wavelengths. Comparing FIG. 5 to FIG. 6, it can be observed that FIG. 6 produces a higher flux of radiation over the narrower wavelength band. This difference is directly related to the photon band gap material 26 working to restrict some of the thermally excited output 30, which would otherwise become emitted photons having undesirable wavelengths, until it bleeds into unrestricted thermally excited output 34 and becomes emitted photons 40 at desirable wavelengths. Hence, the narrower the selected wavelength band of radiation, the greater the magnitude of radiation that may be produced within that selected wavelength band.

FIG. 7 is a cross-sectional view of the invention, in accordance with a second exemplary embodiment of the invention. A night vision device 220 includes an emitter 222 having a surface 224. A band gap material 226 is integral with the surface 224 of the emitter 222. A structure of apertures 228 are formed in the photon band gap material 226. A heat source 242 for heating the emitter 222 is provided proximate to the emitter 222. An infrared viewing system (not shown) is provided for viewing infrared bands of radiation emitted by the emitter 222.

The night vision device 220, as shown in FIG. 7, includes an infrared transmissive housing 246 supporting the emitter 222. The infrared transmissive housing 246 is designed to allow the night vision device 220 to operate as a directed infrared light source. The infrared transmissive housing 246 may, for instance, be mounted to the front of a vehicle for use as infrared headlights, as illustrated in FIG. 1. A driver of the vehicle, possessing an infrared viewing system, could use the infrared headlights to see in low-light/no-light environments without revealing the position of the vehicle. Only those people having an infrared viewing system operating at the appropriate wavelength would be able to locate the vehicle based on the infrared headlights. Similarly, the night vision device 220 could be adapted for use as a flashlight, providing a handheld directed infrared light source.

The infrared transmissive housing 246 may have an open end 248 and a closed end 250. The closed end 250 may tend to be less infrared transmissive than the open end 248. The closed end 250 may further have a reflective surface 252 that redirects infrared radiation away from the closed end 250, back toward the open end 248. In either case the device can be sealed with an appropriately infrared transmissive material.

The flow chart of FIG. 8 shows the functionality and operation of a possible implementation of the night vision device 120. In this regard, each block represents a module, segment, or step, which comprises one or more instructions for implementing the specified function. It should also be noted that in some alternative implementations, the functions noted in the blocks might occur out of the order noted in FIG. 8. For example, two blocks shown in succession in FIG. 8 may in fact be executed non-consecutively, substantially concurrently, or the blocks may sometimes be executed in the reverse order, depending upon the functionality involved, as will be further clarified herein.

FIG. 8 shows a flow chart illustrating a method 300 for enabling vision in the at least partial absence of visible light. The method 300 includes heating the emitter 122 (block 302). The method 300 also includes generating thermally excited outputs (block 304). The thermally excited outputs are received within the photon band gap material 126 (block 306). Photons 140 are emitted from the photon band gap material 126 at wavelengths between approximately 700 nanometers and approximately one millimeter (block 308). The emitted photons 140 are viewed with the infrared viewing system (block 310).

The method 300 may also include limiting a bandwidth of the emitted photons 140 to two microns. Limiting emitted photons 140 to a narrow bandwidth may increase output along that wavelength band. The method 300 may also include reflecting thermally excited outputs back from the emitter surface 124 into the emitter 122 using the photon band gap material 126.

Heating the emitter 122 may involve heating the emitter 122 to a temperature in excess of 500 Kelvin.

It should be emphasized that the above-described embodiments of the present invention are merely possible examples of implementations, simply set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

We claim:

1. A vision device for generating infrared bands of radiation, enabling sight through an infrared viewing system, the device comprising:
an emitter having a surface;
a band gap material integral with the surface of the emitter;
a structure of apertures formed in the photon band gap material; and
a heat source proximate to the emitter.

2. The device of claim 1, further comprising an infrared transmissive housing supporting the emitter.

3. The device of claim 2, wherein the infrared transmissive housing is mounted to a vehicle.

4. The device of claim 2, further comprising a reflector mounted within the infrared transmissive housing thereby reflecting at least a portion of infrared light from the emitter and the photon band gap material toward an infrared transmissive portion of the infrared transmissive housing.

5. The device of claim 1, wherein the emitter and the photon band gap material can withstand temperatures of at least 500 Kelvin without significant degradation.

6. The countermeasure device of claim 1, wherein the photon band gap material is a metal.

7. The countermeasure device of claim 1, wherein each of the apertures in the structure of apertures is uniformly spaced.

8. The countermeasure device of claim 1, wherein each of the apertures in the structure of apertures is equivalently sized.

9. The countermeasure device of claim 1, wherein the emitter is heated to at least 500 Kelvin.

10. A method for generating infrared bands of radiation, enabling sight through an infrared viewing system, the method comprising the steps of:
heating an emitter;
generating thermally excited outputs;
receiving the thermally excited outputs within a band gap material; and
emitting photons from the photon band gap material at wavelengths between approximately 700 nanometers and approximately one millimeter.

11. The method of claim 10, further comprising limiting a bandwidth of the emitted photons to two microns.

12. The method of claim 10, further comprising mounting the emitter within an infrared transmissive housing.

13. The method of claim 12, further comprising mounting the infrared transmissive housing to a vehicle.

14. The method of claim 10, further comprising heating the emitter to a temperature of at least 500 Kelvin.

15. The method of claim 10, further comprising reflecting thermally excited outputs from a surface of the emitter back into the emitter using the photon band gap material.

16. A system for generating infrared bands of radiation, enabling sight through an infrared viewing system, the system comprising:
an emitter for producing thermally excited output;
a heat source for heating the emitter; and
a band gap material for selectively receiving thermally excited output and converting the thermally excited output to emitted photons.

17. The system of claim 16, further comprising a structure of apertures for selecting the thermally excited output to be converted by the photon band gap material.

18. The system of claim 16, wherein the photon band gap material is a metal.

19. The system of claim 16, further comprising a structure of uniformly spaced apertures for selecting the thermally excited output to be converted by the photon band gap material.

20. The system of claim 16, further comprising a housing for mounting the emitter to a vehicle.
